(19) United States
(12) Patent Application Publication
(10) Pub. No.: US 2009/0053589 A1
(43) Pub. Date: Feb. 26, 2009

(54) ELECTROLYTES, ELECTRODE COMPOSITIONS, AND ELECTROCHEMICAL CELLS MADE THEREFROM

(75) Inventors: Mark N. Obrovac, St. Paul, MN (US); Leif Christensen, St. Paul, MN (US); Phat T. Pham, Little Canada, MN (US); William M. Lamanna, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/843,027

(22) Filed: Aug. 22, 2007

(51) Int. Cl. H01M 6/16

(52) U.S. Cl. 429/149; 429/188; 429/199; 429/200

(57) ABSTRACT

Disclosed are electrochemical cells that include electrodes comprising an electrolyte comprising a vinylene carbonate or a halogenated ethylene carbonate, composite electrodes, and a binder.

### FIELD

This invention relates to novel electrolyte formulations and electrode compositions for use in electrochemical cells.

### BACKGROUND

Rechargeable lithium ion batteries are included in a variety of electronic devices. Most commercially available lithium ion batteries have negative electrodes that contain materials such as graphite that are capable of incorporating lithium through an intercalation mechanism during charging. Such intercalation-type electrodes generally exhibit good cycle life and coulombic efficiency. However, the amount of lithium that can be incorporated per unit mass of intercalation-type material is relatively low.

A second class of negative electrode materials is known that incorporate lithium through an alloying mechanism during charging. Although these alloy-type materials can often incorporate higher amounts of lithium per unit mass than intercalation-type materials, the addition of lithium to the alloy is usually accompanied with a large volume change. Some alloy-type negative electrodes exhibit relatively poor cycle life and low energy density. The poor performance of these alloy-type electrodes can result from the large volume changes in the electrode compositions when they are lithiated and then delithiated. The large volume change accompanying the incorporation of lithium can result in the deterioration of electrical contact between the alloy, conductive diluent (e.g., carbon powder), binder, and current collector that typically form the anode. The deterioration of electrical contact, in turn, can result in diminished capacity over the cycle life of the electrode. Electrode composites made with alloy-type materials typically can have high porosities, frequently above 50 percent of the volume of the composite—especially when lithitated. This results in reduction of the energy density of electrochemical cells made with these electrodes containing these types of materials.

### SUMMARY

In view of the foregoing it is recognized that there is a need for electrochemical cells that include negative electrodes having increased cycle life and high energy density.

In one aspect, provided is a lithium ion electrochemical cell having an electrolyte that includes a vinylene carbonate additive having the structure

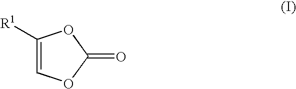

wherein R¹ is H or a C₁-C₄ alkyl or alkenyl group; and an anode composition comprising at least one of: (i) a composition comprising a material having the formula, SiₓSn_{q}M¹_{y}C_{z}, wherein q, x, y, and z represent mol % s and each mol % is based upon the number of moles of all elements except Li in the composition, (q+x)>2y+z,
q and z≧0, M¹ is selected from a transition metal, Y, or a combination thereof, wherein the Si, Sn, M¹, and C elements are arranged in the form of a multi-phase microstructure comprising an amorphous phase comprising Si, a nanocrystalline phase comprising a metal silicide, an amorphous phase comprising Sn when q>0, and a phase comprising a silicon carbide when z>0; (ii) a composition comprising a material having the formula, SiₐAl_{b}M²_{c}Sn_{d}E¹ₑInₚ, wherein a, b, c, d, e, and p represent mol % s and each mol % is based upon the number of moles of all elements except Li in the composition, M² is selected from a transition metal or a combination of transition metals, E¹ comprises Y, a lanthanide, an actinide, or a combination thereof, 35≦a≦70, 1≦b≦45, 5≦c≦25, 1≦d≦15, 2≦e≦15, and 0≦p≦15, and wherein the alloy composition is a mixture of an amorphous phase comprising Si and a nanocrystalline phase comprising E¹ and Sn when p=0 or E¹, Sn, and In when p>0; (iii) a composition comprising a material having the formula, Sn_{f}E²_{g}E³ₕAᵢM³ⱼ, wherein f, g, h, i, and j represent mol % s and each mol % is based upon the number of moles of all elements except Li in the composition, 1≦f≦50, 20≦g≦95, h≧3, i=0 or 3≦i≦50, and 0≦j≦1, E² comprises Si, Al, or a combination thereof, E³ comprises Y, a lanthanide, an actinide, or a combination thereof, “A” comprises an alkaline earth element; and M³ comprises an element selected from Fe, Mg, Si, Mo, Zn, Ca, Cu, Cr, Pb, Ti, Mn, C, S, P, or a combination thereof, or (iv) a composition comprising a material having the formula, SiₖCuₘAgₙ, wherein k, m, and n represent mol % s and each mol % is based upon the number of moles of all elements except Li in the composition, k≧10, m≧3, and wherein 1≦n≦50 based upon moles of the alloy composition.

In another aspect, provided is a lithium ion electrochemical cell having an electrolyte that includes an ethylene carbonate additive with the structure

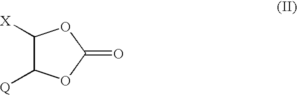

wherein X is H, F, or Cl; and Q is F or Cl or an alkyl or alkenyl group containing one to four carbon atoms an anode composition comprising at least one of: (i) a composition comprising a material having the formula, SiₐAl_{b}M²_{c}Sn_{d}E¹ₑInₚ, wherein a, b, c, d, e, and p represent mol % s and each mol % is based upon the number of moles of all elements except Li in the composition, M² is selected from a transition metal or a combination of transition metals, E¹ comprises Y, a lanthanide, an actinide, or a combination thereof, 35≦a≦70, 1≦b≦45, 5≦c≦25, 1≦d≦15, 2≦e≦15, and
0≦p≦15, and wherein the alloy composition is a mixture of an amorphous phase comprising Si and a nanocrystalline phase comprising E¹ and Sn when p=0 or E¹, Sn, and In when p>0; (ii) a composition comprising a material having the formula, Sn_{f}E²_{g}E³ₕAᵢM³ⱼ, wherein f, g, h, i, and j represent mol % s and each mol % is based upon the number of moles of all elements except Li in the composition, 1≦f≦50, 20≦g≦95, h≧3, i=0 or 3≦i≦50, and 0≦j≦1, E² comprises Si, Al, or a combination thereof, E³ comprises Y, a lanthanide, an actinide, or a combination thereof, “A” comprises an alkaline earth element; and M³ comprises an element selected from Fe, Mg, Si, Mo, Zn, Ca, Cu, Cr, Pb, Ti, Mn, C, S, P, or a combination thereof, or (iii) a composition comprising a material having the formula, SiₖCuₘAgₙ, wherein k, m, and n represent mol % s and each mol % is based upon the number of moles of all elements except Li in the composition, k≧10, m≧3, and wherein 1≦n≦50 based upon moles of the alloy composition.

In yet another aspect, provided is an electrochemical cell having an electrolyte comprising at least one of (a) a vinylene carbonate additive having the structure

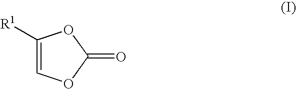

or (b) an ethylene carbonate additive having the structure

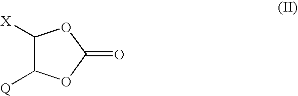

wherein R¹ is H or a C₁-C₄ alkyl or alkenyl group; X is H, F, or Cl; and Q is F or Cl or a C₁-C₄ alkyl or alkenyl group; and an electrode composition comprising particles having an average particle size ranging from about 1 μm to about 50 μm, wherein the particles comprise an electrochemically active phase and an electrochemically inactive phase that share at least one common phase boundary, wherein the electrochemically inactive phase comprises at least two metal elements in the form of an intermetallic compound, a solid solution, or combination thereof, and wherein (i) each of the phases is free of crystallites that are greater than 1000 angstroms prior to cycling, and (ii) the electrochemically active phase is amorphous after the electrode has been cycled through one full charge-discharge cycle in a lithium-ion battery.

In this disclosure:

the articles “a”, “an”, and “the” are used interchangeably with “at least one” to mean one or more of the elements being described;

the term “alloy” refers to a homogeneous mixture or solid solution of two or more metals;

the terms “charge” and “charging” refer to a process for providing electrochemical energy to a cell;

the terms “discharge” and “discharging” refer to a process for removing electrochemical energy from a cell, e.g., when using the cell to perform desired work;

the term “electrochemically active” refers to a composite material that can reversibly incorporate lithium;

the term “electrochemically inactive” refers to a composite material than is not capable of reversibly incorporating lithium into its morphological structure.

the terms “lithiate” and “lithiation” refer to a process for adding lithium to an electrode material;

the term “lithiated”, when it refers to a negative electrode, means that the electrode has incorporated lithium ions in an amount greater than 10 wt % of the total weight of the electrode material;

the term “mol %”, when referring to constituents of the compositions described herein, is calculated based upon the total number of moles of all elements in the compositions except lithium. For example, the mol % silicon in a composition that contains silicon, aluminum, transition metal, tin, and a fifth element is calculated by multiplying the number of moles of silicon by 100 and dividing this product by the total moles of all elements except lithium in the composition (if it is present);

the terms “delithiate” and “delithiation” refer to a process for removing lithium from an electrode material;

the phrase “negative electrode” refers to an electrode (often called an anode) where electrochemical oxidation and delithiation occurs during a discharging process; and

the phrase “positive electrode” refers to an electrode (often called a cathode) where electrochemical reduction and lithiation occurs during a discharging process.

Unless the context clearly requires otherwise, the terms “aliphatic”, “cycloaliphatic” and “aromatic” include substituted and unsubstituted moieties containing only carbon and hydrogen, moieties that contain carbon, hydrogen and other atoms (e.g., nitrogen or oxygen ring atoms), and moieties that are substituted with atoms or groups that can contain carbon, hydrogen or other atoms (e.g., halogen atoms, alkyl groups, ester groups, ether groups, amide groups, hydroxyl groups or amine groups). “Alkyl” refers to a saturated hydrocarbon radical and “alkenyl” refers to an unsaturated hydrogen radical.

It is an advantage of various embodiments of the present invention to provide electrochemical cells that include negative electrodes having increased cycle life and high energy densities. These cells incorporate at least one of a vinylene carbonate additive, an ethylene carbonate additive, or a combination thereof, in the electrolyte. The carbonate additives significantly increase the cycle life of the cells which results in extended uses and the ability to maintain high energy densities throughout the lifetime of the cell.

### DETAILED DESCRIPTION

All numbers are herein assumed to be modified by the term “about”. The recitation of numerical ranges by endpoints includes all numbers subsumed within that range (e.g., 1 to 5 includes 1, 1.5, 2, 2.75, 3, 3.80, 4, and 5).

Electrochemical cells of this disclosure include at least one positive electrode, at least one negative electrode, at least one separator, a binder, and an electrolyte. The positive electrode or the negative electrode or both electrodes can include a composite and a binder. A variety of electrolytes can be employed in the disclosed lithium-ion cell. Representative electrolytes can contain one or more lithium salts and the electrolyte can be in the form of a solid, liquid or gel. Alternatively, electrolytes can be referred to as “charge-carrying media”.

Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary electrolytes are stable without freezing or boiling in the temperature range within which the cell electrodes can operate, are capable of dissolving sufficient quantities of the lithium salt so that a suitable quantity of charge can be transported from the positive electrode to the negative electrode, and perform well in the chosen lithium-ion cell.

Exemplary solid electrolytes can include polymeric media such as polyethylene oxide, polytetrafluoroethylene, polyvinylidene fluoride, fluorine-containing copolymers, polyacrylonitrile, combinations thereof and other solid media that will be familiar to those skilled in the art. Exemplary liquid electrolytes can include ethylene carbonate, propylene carbonate, dimethyl carbonate, diethyl carbonate, ethyl-methyl carbonate, butylene carbonate, γ-butylrolactone, methyl difluoroacetate, ethyl difluoroacetate, dimethoxyethane, diglyme (bis(2-methoxyethyl)ether), tetrahydrofuran, dioxolane, and combinations thereof. Exemplary electrolyte gels include those described in U.S. Pat. Nos. 6,387,570 (Nakamura et al.), and 6,780,544 (Noh). The electrolyte solubilizing power can be improved through the addition of a suitable cosolvent. Exemplary cosolvents can include aromatic materials compatible with Li-ion cells containing the chosen electrolyte. Representative cosolvents can include toluene, sulfolane, dimethoxyethane, combinations thereof and other cosolvents that will be familiar to those skilled in the art.

The electrolyte can include other additives that will be familiar to those skilled in the art. For example, the electrolyte can contain a redox chemical shuttle such as those described in U.S. Pat. Nos. 5,709,968 (Shimizu), 5,763,119 (Adachi), 5,536,599 (Alamgir et al.), 5,858,573 (Abraham et al.), 5,882,812 (Visco et al.), 6,004,698 (Richardson et al.), 6,045,952 (Kerr et al.), and 6,387,571 (Lain et al.), and in U.S. Pat. Appl. Publ. Nos. 2005/0221168, 2005/0221196, 2006/0263696, and 2006/0263697 (all to Dahn et al.). These are all herein incorporated by reference.

Electrolytes of this disclosure can include an additive such as the vinylene carbonates having Structure I where R is H or a C₁-C₄ alkyl or alkenyl group.

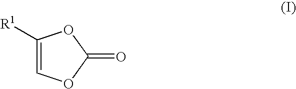

Exemplary additives of Structure (I) that can be useful in various embodiments of this invention include, but are not limited to, vinylene carbonate, methylvinylene carbonate, ethylvinylene carbonate, propylvinylene carbonate, isopropylvinylene carbonate, butylvinylene carbonate, isobuylvinylene carbonate, and the like. Alternatively or additionally the electrolytes of this disclosure can include ethylene carbonates having Structure II wherein X is hydrogen, fluorine or chlorine; and Q is fluorine or chlorine or a C₁-C₄ alkyl or alkenyl group.

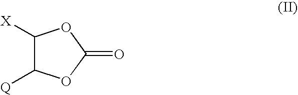

Exemplary additives of Structure (II) that can be useful in various embodiments of this invention include, but are not limited to, fluoroethylene carbonate, chloroethylene carbonate, 1,2-difluoroethylene carbonate, 1-fluoro-2-methylethylene carbonate, 1-chloro-2-methyethylene carbonate, vinylethylene carbonate and the like. The additives such as those exemplified in Structures (I) and (II) can be added to the electrolyte in an amount greater than about 0.5 wt % (wt %), greater than about 1.0 wt %, greater than about 5 wt %, greater than about 10 wt %, greater than about 20 wt %, greater than about 50 wt % or even greater, of the total weight of the electrolyte.

Positive electrodes of the electrochemical cells, batteries or battery packs of this invention include lithium. The electrodes can be in the form of a composite. Examples of materials useful in positive electrodes include, LiV₃O₈, LiV₂O₅, LiCO_{0.2}Ni_{0.8}O₂, LiNi_{0.33}Mn_{0.33}CO_{0.33}, LiNi_{0.5}Mn_{0.3}CO_{0.2}, LiNiO₂, LiFePO₄, LiMnPO₄, LiCoPO₄, LiMn₂O₄, and LiCoO₂; the positive electrode materials that include mixed metal oxides of cobalt, manganese, and nickel such as those described in U.S. Pat. Nos. 6,964,828, 7,078,128 (both to Lu et al.), and 6,660,432 (Paulsen et al.); and nanocomposite positive electrode materials such as those discussed in U.S. Pat. No. 6,680,145 (Obrovac et al.) all of which are herein incorporated by reference.

A variety of materials can be employed in the negative electrodes of this disclosure. The materials can be in the form of a single chemical element or a composite. Examples of materials useful for making composites used in the negative electrodes of this disclosure include alloy compositions having the formula, SiₓSn_{q}M¹_{y}C_{z} where q, x, y, and z represent atomic percent values and (a) (q+x)>2y+z; (b) q≧0, (c) z≧0; and (d) M¹ is selected from a transition metal, Y, or a combination thereof. Transition metals include one or more metals selected from manganese, molybdenum, niobium, tungsten, tantalum, iron, copper, titanium, vanadium, chromium, nickel, cobalt, zirconium, yttrium, or combinations thereof. The Si, Sn, M¹, and C elements are arranged in the form of a multi-phase microstructure comprising: (a) an amorphous phase comprising silicon (thus, x>0); (b) a nanocrystalline phase comprising a metal silicide; and (c) a phase comprising silicon carbide when z>0; and (d) an amorphous phase comprising Sn when q>0. These electrode compositions are disclosed, for example, in U.S. Pat. Publ. No. 2007/0148544 (Le), published on Jun. 28, 2007, which is herein incorporated by reference. Preferably, the electrode compositions are prepared by ball-milling silicon, the other metal(s), and, in embodiments where carbon is used, a carbon source (e.g., graphite), under high shear and high impact for an appropriate period of time. Ball-mills such as a vertical ball mill (ATTRITOR, Union Process Inc., Akron, Ohio), a SPEXMILL (Spex CertiPrep, Metuchen, N.J.), a horizontal rotary ball mill (SIMOLOYER, Zoz GmbH, Werden, Germany) or other ball mills known in the art also may be used.

Another example of compositions useful for making composites used in the negative electrodes of electrochemical cells of this disclosure include alloy compositions having the formula SiₐAl_{b}M²_{c}Sn_{d}E¹ₑInₚ, wherein a, b, c, d, e, and p represent mol % s and each mol % is based upon the number of moles of all elements except Li in the composition, M² is selected from a transition metal or a combination of transition metals, E¹ comprises Y, a lanthanide, an actinide, or a combination thereof, 35≦a≦70, 1≦b≦45, 5≦c≦25, 1≦d≦15, 2≦e≦15, and 0≦p≦15, and wherein the alloy composition is a mixture of an amorphous phase comprising Si and a nanocrystalline phase comprising E¹ and Sn when p=0 or E¹, Sn, and In when p>0. M² can be selected from titanium, vanadium, chromium, manganese, iron, cobalt, nickel, copper, zirconium, niobium, molybdynum, tungsten, or a combination thereof. These electrode compositions are disclosed in U.S. Pat. Publ. Nos. 2007/0020521 and 2007/0020522 (both Obrovac et al.) both published on Jan. 25, 2007 which are herein incorporated by reference.

In the alloy composition, SiₐAl_{b}M²_{c}Sn_{d}E¹ₑInₚ, described above, the amorphous phase contains silicon while the nanocrystalline phase is substantially free of silicon. As used herein, the term “substantially free” when referring to the nanocrystalline phase means that the substance (e.g., elemental silicon, elemental tin, elemental indium, or the indium-tin binary intermetallic compound) cannot be detected using known x-ray diffraction techniques. The nanocrystalline phase contains an intermetallic compound that includes tin and indium, if it is present. The amorphous nature of the alloy composition can be characterized by the absence of sharp peaks in the x-ray diffraction pattern. The x-ray diffraction pattern can have broad peaks, such as peaks having a peak width at half the maximum peak height corresponding to at least 5 degrees 2θ, at least 10 degrees 2θ, or at least 15 degrees 2θ using a copper target (i.e., copper Kα1 line, copper Kα2 line, or a combination thereof).

Nanocrystalline materials typically have a maximum crystallite dimension of about 5 nm to about 50 nm. The crystalline size can be determined from the width of an x-ray diffraction peak using the Sherrer equation. Narrower x-ray diffraction peaks correspond to larger crystal sizes. The x-ray diffraction peaks for nanocrystalline materials typically have a peak width at half the maximum peak height corresponding to less than 5 degrees 2 θ, less than 4 degrees 2θ, less than 3 degrees 2θ, less than 2 degrees 2θ, or less than 1 degree 2θ using a copper target (i.e., copper Kα1 line, copper Kα2 line, or a combination thereof).

Because the rate of lithiation is generally greater for nanocrystalline material than for amorphous material, it can be desirable to include some nanocrystalline material in alloy compositions. In some embodiments, the presence of elemental silicon in a crystalline phase, however, can result in the formation of crystalline Li₁₅Si₄ during cycling when the voltage of the anode drops below about 50 mV versus a metallic Li/Li ion reference electrode. The formation of crystalline Li₁₅Si₄ during lithiation can adversely affect the cycle life of the anode (i.e., the capacity tends to diminish with each cycle of lithiation and delithiation). To minimize or prevent the formation of Li₁₅Si₄ crystals, it is advantageous for silicon to be present in the amorphous phase and to remain in the amorphous phase after repetitive cycles of lithiation and delithiation. The addition of a transition metal can facilitate the formation of an amorphous silicon-containing phase and minimize or prevent the formation of a crystalline silicon-containing phase (e.g., crystalline elemental silicon or crystalline silicon-containing compounds).

In this embodiment of the invention, the nanocrystalline phase of the alloy composition, SiₐAl_{b}M²_{c}Sn_{d}E¹ₑInₚ, includes tin, which is another electrochemically active material. The presence of crystalline elemental tin, however, can be detrimental to the capacity when the anode is subjected to repetitive cycles of lithiation and delithiation. As used herein, the term “elemental” refers to an element of the periodic table (e.g., tin, silicon, indium, or the like) that is present as a pure element rather than combined with another element in the form of a compound, such as an intermetallic compound.

To minimize the formation of crystalline elemental tin, an intermetallic compound can be formed that contains (1) tin, (2) indium (if present), and (3) an element that contains yttrium, a lanthanide element, an actinide element, or a combination thereof. The intermetallic compound can be, for example, of formula [Sn₍₁₋ₚ₎Inₚ]₃E¹ where E¹ is an element that contains yttrium, a lanthanide element, an actinide element, or a combination thereof and 0<p<1. In the absence of the indium it can be difficult to control the crystallite size using some formation processes. For example, when an alloy is formed using a melt spinning technique without any indium, relatively large crystals of elemental tin can form. Indium tends to impede the formation of crystalline elemental tin and increases the capacity of the alloy composition. Additionally, the addition of indium tends to facilitate the use of melt processing techniques such as melt spinning to form the alloy composition and increases the likelihood that an amorphous phase will form rather than a large crystalline phase.

In another embodiment of the invention the alloy composition, SiₐAl_{b}M²_{c}Sn_{d}E¹ₑInₚ, includes an amorphous phase that includes substantially all of the silicon. Silicon is present in the alloy composition in an amount of 35 to 70 mol % based on the total number of moles of all elements except lithium in the alloy composition. If the amount of silicon is too low, the capacity can be unacceptably low. If the amount of silicon is too high, however, silicon-containing crystals tend to form. The presence of crystalline silicon, at least in some embodiments, can lead to the formation of Li₁₅Si₄ during cycling when the voltage of the anode drops below about 50 mV versus a metallic Li/Li ion reference electrode. Crystalline Li₁₅Si₄ can detrimentally affect the cycle life of a lithium ion battery. The alloy composition contains at least 35 mol %, at least 45 mol %, at least 50 mol %, at least 55 mol %, or at least 60 mol % silicon. The alloy composition can contain below about 70 mol %, below about 65 mol %, or below about 60 mol % silicon. For example, the alloy composition, SiₐAl_{b}M²_{c}Sn_{d}E¹ₑInₚ, can contain 40 to 70 mol %, 50 to 70 mol %, 55 to 70 mol %, or 55 to 65 mol % silicon. The amorphous phase typically includes all or a portion of the aluminum and all or a portion of the transition metal in this embodiment.

Another example of compositions useful for making composites used in the negative electrodes of electrochemical cells of this disclosure includes alloy compositions having the formula, Sn_{f}E²_{g}E³ₕAᵢM³ⱼ, wherein f, g, h, i, and j represent mol % s, 1≦f≦50, 20≦g≦95, h≧3, i=0 or 3≦i≦50, and 0≦j≦1, E² comprises Si, Al, or a combination thereof, E³ comprises Y, a lanthanide, an actinide, or a combination thereof, “A” comprises an alkaline earth element; and M³ comprises an element selected from Fe, Mg, Si, Mo, Zn, Ca, Cu, Cr, Pb, Ti, Mn, C, S, P, or a combination thereof. These alloy compositions are disclosed, for example, in U.S. Pat. Publ. No. 2007/0020528 (Obrovac et al.) published Jan. 25, 2007 which is herein incorporated by reference. The entire alloy composition, Sn_{f}E²_{g}E³ₕAᵢM³ⱼ, is typically amorphous. The alloy composition, Sn_{f}E²_{g}E³ₕAᵢM³ⱼ, is amorphous at ambient temperatures such as at temperatures in the range of 10° C. to 50° C. This alloy composition is amorphous before undergoing a cycle of lithiation and delithiation and remains amorphous after at least ten cycles of lithiation and delithiation when incorporated into a lithium ion battery. Some alloy compositions remain amorphous after at least 100, at least 500, or at least 1000 cycles of lithiation and delithiation.

The alloy composition, Sn_{f}E²_{g}E³ₕAᵢM³j is amorphous and remains amorphous even after repetitive cycles of lithiation and delithiation. That is, it does not contain a crystalline phase that can be detected using known x-ray diffraction techniques. The amorphous nature of the alloy compositions can be characterized by the absence of sharp peaks, which are characteristic of crystalline materials, in the x-ray diffraction pattern. The alloy composition contains (a) tin, (b) E², a second element that includes silicon, aluminum, or a combination thereof, (c) E³, a third element that includes yttrium, a lanthanide element, an actinide element, or a combination thereof, “A”, an optional alkaline earth element, and (d) M³, an optional transition metal. The alloy composition is amorphous at ambient temperatures such as at temperatures in the range of 10° C. to 50° C. The alloy composition is amorphous before undergoing a cycle of lithiation and delithiation and remains amorphous after at least ten cycles of lithiation and delithiation. Some alloy compositions remain amorphous after at least 100, at least 500, or at least 1000 cycles of lithiation and delithiation.

In the composition, Sn_{f}E²_{g}E³ₕAᵢM³ⱼ, tin is present in an amount of 1 to 50 mol % based on the total number of moles of all elements in the alloy composition except lithium. Tin is an electrochemically active element that can undergo lithiation. The amount of tin affects the kinetics of lithiation as well as the capacity. Higher levels of tin tend to increase the rate of lithiation and the capacity. An increased rate of lithiation can diminish the amount of time needed to charge a battery. If the amount of tin is increased too much, however, a crystalline phase containing tin (e.g., elemental tin) can form in the alloy composition. The presence of a crystalline phase can, at least in some embodiments, have a detrimental impact on the capacity when the anode is subjected to repetitive cycles of lithiation and delithiation. A decreased capacity lowers the time a battery can be used before it needs to be recharged.

The alloy composition, Sn_{f}E²_{g}E³ₕAᵢM³ⱼ, can include at least 1 mol %, at least 5 mol %, at least 10 mol %, or at least 15 mol % tin. The alloy composition can include below about 50 mol %, below about 45 mol %, below about 40 mol %, below about 35 mol %, below about 30 mol %, below about 25 mol %, below about 20 mol % tin. For example, the alloy compositions can contain 1 to 40 mol %, 1 to 30 mol %, 1 to 20 mol %, 10 to 40 mol %, 10 to 30 mol %, 10 to 25 mol %, 15 to 30 mol %, or 15 to 25 mol % tin.

The alloy composition, Sn_{f}E²_{g}E³ₕAᵢM³ⱼ, can contain a second element, E², that includes silicon, aluminum, or a combination thereof present in an amount of from about 20 to about 95 mol % based on the total number of moles of all elements in the alloy composition except lithium. At least some of the second element is electrochemically active. If the amount of the second element in the alloy composition is too low, the capacity can be unacceptably low. If the amount of the second element is too high, however, the second element can crystallize. A crystalline phase can, at least in some embodiments, detrimentally affect the capacity when the anode is subjected to repetitive lithiation and delithiation cycles. That is, the capacity can decrease with successive cycles of lithiation and delithiation.

In some alloy compositions, all of the second element, E², can be electrochemically active. In other alloy compositions, a portion of the second element can be electrochemically active and a portion of the second element can be electrochemically inactive. Any portion of the second element that is electrochemically inactive can function as a matrix that does not undergo lithiation or delithiation during charging or discharging of a lithium ion battery.

In some alloy compositions, the second element, E², is present in an amount of from about 20 to about 90 mol %, from about 20 to about 80 mol %, from about 20 to about 70 mol %, from about 20 to about 60 mol %, from about 20 to about 50 mol %, from about 20 to about 40 mol %, from about 30 to about 90 mol %, from about 40 to about 90 mol %, about 50 to about 90 mol %, from about 60 to about 90 mol %, from about 70 to about 90 mol %, from about 30 to about 80 mol %, from about 40 to about 80 mol %, from about 30 to about 70 mol %, or even from 40 to about 70 mol %.

In some exemplary alloy compositions, the second element, E², can be silicon and the silicon is present in an amount of at least 40 mol %, at least 45 mol %, at least 50 mol %, or at least 55 mol %. The silicon can be present in an amount below about 90 mol %, below about 85 mol %, or below about 80 percent. For example, the alloy composition can contain from about 40 to about 90 mol %, from about 45 to about 90 mol %, from about 50 to about 90 mol %, from about 55 to about 90 mol %, from about 40 to about 80 mol %, from about 50 to about 80 mol %, or from about 55 to about 80 mol % silicon.

In other exemplary alloy compositions, the second element, E², can be aluminum and the aluminum can be present in an amount of at least 40 mol %, at least 45 mol %, at least 50 mol %, or at least 55 mol %. The aluminum can be present in an amount below about 90 mol %, below about 80 mol %, below about 70 mol %, below about 65 mol %, or even below about 60 mol %. For example, the alloy composition can contain from about 40 to about 90 mol %, from about 50 to about 90 mol %, from about 55 to about 90 mol %, from about 50 to about 80 mol %, from about 55 to about 80 mol %, from about 50 to about 70 mol %, from about 55 to about 70 mol %, from about 50 to about 65 mol %, or even from about 55 to about 65 mol % aluminum.

In still other exemplary alloy compositions, the second element, E², can be a mixture of silicon and aluminum. The amount of silicon can be greater than, less than, or equal to the amount of aluminum in alloy composition. Higher levels of silicon tend to increase the capacity of the alloy composition. Higher levels of aluminum can lower the melting point of the alloy composition, which facilitates the use of a greater variety of processing techniques such as melt processing techniques (e.g., melt spinning). In some alloy compositions, aluminum is present in an amount of from about 50 to about 70 mol % and silicon is present in an amount below about 20 mol %. For example, the alloy compositions can contain from about 50 to about 70 mole aluminum and from about 1 to about 15 mole mol % silicon or from about 55 to about 65 mol % aluminum and from about 1 to about 10 mol % silicon.

The alloy composition, Sn_{f}E²_{g}E³ₕAᵢM³ⱼ, can contain 3 to 50 mol % of a third element, E³, based on the total moles of all elements in the alloy composition except lithium. The third element can include yttrium, a lanthanide element, an actinide element, or a combination thereof and can further include “A”, an optional alkaline earth element. The third element can react more readily with tin than the second element and can facilitate the incorporation of tin into the amorphous phase. If too much of the third element is included in the alloy composition, the resulting alloy composition is often not air stable and the capacity tends to become too small due to the formation of an electrochemically inactive intermetallic compound between silicon and the third element. If too little of the third element is included in the alloy composition, however, crystalline tin (e.g., elemental tin) can be present in the alloy composition. The presence of crystalline tin, at least in some embodiments, can disadvantageously reduce the capacity with each repetitive cycle of lithiation and delithiation.

The third element, E³, usually does not combine with silicon from the second element, E², to form a stoichiometric compound such as a silicide. The third element can include yttrium, a lanthanide element, an actinide element, or a combination thereof. Suitable lanthanide elements include lanthanum, cerium, praseodymium, neodymium, promethium, samarium, europium, gadolinium, terbium, dysprosium, holmium, erbium, thulium, ytterbium, and lutetium. Suitable actinide elements include thorium, actinium, and protactinium. Some alloy compositions contain a lanthanide elements selected, for example, from cerium, lanthanum, praseodymium, neodymium, or a combination thereof.

The third element can be a Mischmetal, which is an alloy of various lanthanides. Some Mischmetals contain, for example, from about 45 to about 60 wt % cerium, from about 20 to about 45 wt % lanthanum, from about 1 to about 10 wt % praseodymium, and from about 1 to about 25 wt % neodymium. Other exemplary Mischmetals contain from about 30 to about 40 wt % lanthanum, from about 60 to about 70 wt % cerium, less than about 1 wt % praseodymium, and less than about 1 wt % neodymium. Still other exemplary Mischmetals contain from about 40 to about 60 wt % cerium and from about 40 to about 60 wt % lanthanum. The Mischmetal often includes small impurities (e.g., no more than about 3 wt %, no more than about 2 wt %, not more than about 1 wt %, no more than about 0.5 wt %, or no more than about 0.1 wt %) such as, for example, iron, magnesium, silicon, molybdenum, zinc, calcium, copper, chromium, lead, titanium, manganese, carbon, sulfur, phosphorous, and the like. The Mischmetal often has a lanthanide content of at least about 97 wt %, at least about 98 wt %, or at least about 99 wt %. One exemplary Mischmetal that is commercially available from Alfa Aesar, Ward Hill, Mass. with 99.9 wt % purity contains approximately 50 wt % cerium, 18 wt % neodymium, 6 wt % praseodymium, 22 wt % lanthanum, and 3 wt % other rare earths.

The alloy composition, Sn_{f}E²_{g}E³ₕAᵢM³ⱼ, can optionally include an alkaline earth element, “A”. “A” can include alkaline earth elements such as, for example, magnesium, calcium, barium, strontium, or a combination thereof. In some alloy compositions the alkaline earth element is calcium. The amount of calcium can be present in any amount below about 25 mol %. Some alloy compositions contain an alkaline earth element in an amount below about 15 mol %, below about 10 mol %, below about 5 mol %, or below about 3 mol %.

Another example of compositions useful for making composites used in the negative electrodes of electrochemical cells of this disclosure comprise alloy compositions having the formula SiₖCuₘAgₙ wherein k, m, and n represent mol % s, k≧10, m≧3, and 1≦n≦50 based upon moles of the alloy composition. These compositions are disclosed, for example, in U.S. Pat. Publ. No. 2006/0046144 (Obrovac), published Mar. 2, 2006 which is herein incorporated by reference.

The alloy composition comprising the formula, SiₖCuₘAgₙ, includes at least about 10 mol %, at least about 20 mol %, at least about 30 mol %, at least about 35 mol %, or at least about 40 mol % silicon. The alloy compositions can include below about 90 mol %, below about 85 mol %, below about 80 mol %, below about 70 mol %, or below about 60 mol % silicon. For example, the silicon content can be from about 10 to about 90 mol %, from about 20 to about 85 mol %, from about 30 to about 80 mol %, from about 35 to about 70 mol %, or from about 40 to about 60 mol % based on moles of the alloy composition.

The alloy composition, SiₖCuₘAgₙ, can include at least about 3 mol % copper. Some alloy compositions include at least about 10 mol %, at least about 20 mol %, at least about 30 mol %, or at least about 40 mol % copper. If lower amounts of copper are used, it can be difficult to adequately suppress the formation of crystalline Li₁₅Si₄ during lithiation at potentials less than 50 mV versus a Li/Li⁺ reference electrode. That is, copper in combination with silver or a silver alloy can suppress the formation of crystalline Li₁₅Si₄ during lithiation at potentials less than 50 mV versus a Li/Li⁺ reference electrode. Exemplary alloy compositions include from about 3 to about 60 mol %, from about 10 to about 60 mol %, from about 20 to about 60 mol %, or from about 30 to about 60 mol % copper.

The copper is often present in the form of a copper silicide (e.g., Cu₃Si). Silicon in the form of copper silicide tends to be electrochemically active. If aluminum is present as a matrix former, higher levels of copper can be used to ensure the formation of copper silicide. That is, copper tends to be more reactive with aluminum than silicon; to ensure that there is some copper silicide present, higher levels of copper can be used in the presence of aluminum (e.g., aluminum and copper can combine to form an alloy that is electrochemically inactive).

The combination of copper with silver or a silver alloy can tend to suppress the formation of crystalline Li₁₅Si₄ during lithiation at potentials less than about 50 mV versus a Li/Li⁺ reference electrode. That is, silver or the silver alloy enhances the suppression of the crystalline Li₁₅Si₄ over the suppression caused by copper alone. Suitable silver alloys include silver combined with at least one electrochemically active metal such as, for example, tin, gallium, indium, zinc, lead, germanium, bismuth, aluminum, cadmium, or a combination thereof. In some exemplary alloy compositions, the silver alloy is a mixture of silver and tin (e.g., Ag₄Sn) or silver and zinc.

The alloy composition comprising the formula, SiₖCuₘAgₙ, includes at least about 1 mol %, at least about 2 mol %, at least about 3 mol %, at least about 5 mol %, at least about 10 mol %, or at least about 20 mol % silver or silver alloy. The alloy composition can include below about 50 mol %, below about 40 mol %, below about 30 mol %, or below about 20 mol % silver or silver alloy. For example, the alloy composition can include from about 1 to about 50 mol %, from about 2 to about 50 mol %, from about 2 to about 40 mol %, from about 2 to about 30 mol %, or from about 2 to about 20 mol % silver or silver alloy. Some silver alloys contain at least about 50 mol %, at least about 60 mol %, at least about 70 mol %, at least about 80 mol %, or at least about 90 mol % silver.

Some exemplary alloy compositions comprising the formula, SiₖCuₘAgₙ, further comprise aluminum. The aluminum can act as an electrochemically active material, an electrochemically inactive material, or a combination thereof. If aluminum is alloyed with silver, the aluminum is in an electrochemically active form. However, if the aluminum is alloyed with a matrix former, or a combination of silicon and a matrix former, the aluminum is present in an electrochemically inactive form. The alloy composition can include below about 60 atomic percent, below about 50 atomic percent, below about 40 atomic percent, below about 30 atomic percent, below about 20 atomic percent, below about 10 atomic percent, or below about 5 atomic percent aluminum.

The alloy compositions of various embodiments of this disclosure can also include matrix formers. The matrix formers can combine with some of the silicon or aluminum that may be present to provide a matrix that is electrochemically inactive. The resulting matrix includes metal silicides, metal aluminides, ternary metal-silicon-aluminum alloys, or a combination thereof. The addition of the matrix former can decrease the volume change encountered when the alloy composition undergoes lithiation and delithiation. Exemplary matrix formers include, for example, transition metals, rare earth metal, or combinations thereof. Suitable matrix formers include, but are not limited to, nickel, cobalt, iron, manganese, titanium, chromium, molybdenum, niobium, tungsten, tantalum, lanthanum, cerium, Misch metal (i.e., a mixture of rare earth metals), or a combination thereof. Some alloy compositions include below about 86 mol %, below about 80 mol %, below about 60 mol %, below about 40 mol %, below about 20 mol %, below about 10 mol %, or below about 5 mol % matrix former.

In another embodiment, electrode compositions that are useful in negative electrodes used in electrochemical cells of this disclosure include electrode compositions comprising particles having an average particle size ranging from about 1 μm to about 50 μm, and comprising an electrochemically active phase and an electrochemically inactive phase that share at least one common phase boundary, wherein the electrochemically inactive phase comprises at least two metal elements in the form of an intermetallic compound, a solid solution, or combination thereof, and wherein (a) each of the phases is free of crystallites that are greater than 1000 angstroms prior to cycling, and (b) the electrochemically active phase is amorphous after the electrode has been cycled through one full charge-discharge cycle in a lithium-ion battery. These electrode compositions are disclosed, for example, in U.S. Pat. Publ. No. 2005/0031957 (Christensen et al.) which is herein incorporated by reference.

The electrochemically active phase can include metals or metal alloys that are capable of incorporating lithium into their lattice structure. Electrochemically active metals or metal alloys can include, for example, silicon, tin, antimony, magnesium, zinc, cadmium, indium, aluminum, bismuth, germanium, lead, alloys thereof, and combinations thereof. Electrochemically active metal alloys include alloys containing silicon; tin; a transition metal and, optionally carbon; alloys containing silicon, a transition metal, and aluminum; alloys containing silicon, copper, and silver; and alloys containing tin, silicon or aluminum, yttrium, and a lanthanide or an actinide or a combination thereof. In some embodiments the electrochemically active phase can comprise, or even consist essentially of, silicon (e.g., silicon powder). For example, in the case of silicon particles, the amount of silicon particles is typically in a range of from about 10 to about 95 percent by weight, with correspondingly higher weight percentages being typically used for electrochemically active particles with higher densities.

The electrode compositions can typically be in the form of powders. Powders can have a maximum length in one dimension that is less than about 100 μm, less than about 80 μm, less than about 60 μm, less than about 40 μm, less than about 20 μm, less than about 2 μm, or even smaller. The powdered materials can, for example, have a particle diameter that is submicron, at least about 0.5 μm, at least about 1 μm, at least about 2 μm, at least about 5 μm, or at least about 10 μm or even larger. For example, suitable powders often have dimensions from about 0.5 μm to about 100 μm, from about 0.5 μm to about 80 μm, from about 0.5 μm to about 60 μm, from about 0.5 μm to about 40 μm, from about 0.5 μm to about 2.0 μm, from about 1.0 μm to about 50 μm, from about 10 to about 60 μm, from about 20 to about 60 μm, from about 40 to about 60 μm, from about 20 to about 40 μm, from about 10 to about 40 μm, from about 5 to about 20 μm, or from about 10 to about 20 μm. The powdered materials can contain optional matrix formers. Each phase originally present in the particle (i.e., before a first lithiation) can be in contact with other phases in the particle. For example, in particles based on a silicon:copper:silver alloy, a silicon phase can be in contact with both a copper silicide phase and a silver or silver alloy phase. Each phase in a particle can for example have a grain size less than about 50 nm, less than about 40 nm, less than about 30 nm, less than about 20 nm, less than about 15 nm, or even smaller.

Exemplary silicon-containing electrochemically active materials include silicon alloys wherein the active material comprises from about 50 to about 85 mol % silicon, from about 5 to about 12 mol % iron, from about 5 mol % to about 12 mol % titanium, and from about 5 to about 12 mol % carbon. Additionally, the active material can be pure silicon. More examples of useful silicon alloys include compositions that include silicon, copper, and silver or silver alloy such as those discussed in U.S. Pat. Appl. Publ. No. 2006/0046144 (Obrovac et al.); multiphase, silicon-containing electrodes such as those discussed in U.S. Pat. Appl. Publ. No. 2005/0031957 (Christensen et al.); silicon alloys that contain tin, indium and a lanthanide, actinide element or yttrium such as those described in U.S. Ser. Nos. 11/387,205, 11/387,219, and 11/387,557 (all to Obrovac et al.); amorphous alloys having a high silicon content such as those discussed in U.S. Ser. No. 11/562,227 (Christensen et al.); other powdered materials used for electrodes such as those discussed in U.S. Ser. No. 11/419,564 (Krause et al.); U.S. Ser. No. 11/469,561 (Le); PCT Publ. No. WO 2007/044315 (Krause et al.), and U.S. Pat. No. 6,203,944 (Turner). Additional useful electrochemically active materials useful in various embodiments of this invention are described in U.S. Pat. Appl. Publ. No. 2003/0211390 (Dahn et al.), U.S. Pat. Nos. 6,255,017 (Turner), 6,436,578 (Turner et al.), and 6,699,336 (Turner et al.), combinations thereof and other powdered materials that will be familiar to those skilled in the art. Each of the foregoing references is herein incorporated by reference in its entirety.

Electrodes of this disclosure include a binder. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of polymer binders include polymers or copolymers of vinylidene fluoride, tetrafluoroethylene, and propylene; and copolymers of vinylidene fluoride and hexafluoropropylene.

In some electrodes, the binders are crosslinked. Crosslinking can improve the mechanical properties of the binders and can improve the contact between the alloy composition and any electrically conductive diluent that can be present. In other anodes, the binder is a polyimide such as the aliphatic or cycloaliphatic polyimides described in U.S. Ser. No. 11/218,448, filed on Sep. 1, 2005. Such polyimide binders have repeating units of Formula (III)

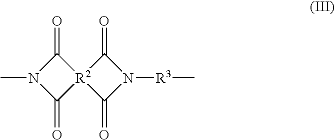

where R² is aliphatic or cycloaliphatic; and R³ is aromatic, aliphatic, or cycloaliphatic.

The aliphatic or cycloaliphatic polyimide binders can be formed, for example, using a condensation reaction between an aliphatic or cycloaliphatic polyanhydride (e.g., a dianhydride) and an aromatic, aliphatic or cycloaliphatic polyamine (e.g., a diamine or triamine) to form a polyamic acid, followed by chemical or thermal cyclization to form the polyimide. The polyimide binders can also be formed using reaction composites additionally containing aromatic polyanhydrides (e.g., aromatic dianhydrides), or from reaction composites containing copolymers derived from aromatic polyanhydrides (e.g., aromatic dianhydrides) and aliphatic or cycloaliphatic polyanhydrides (e.g., aliphatic or cycloaliphatic dianhydrides). For example, about 10 to about 90 percent of the imide groups in the polyimide can be bonded to aliphatic or cycloaliphatic moieties and about 90 to about 10 percent of the imide groups can be bonded to aromatic moieties. Representative aromatic polyanhydrides are described, for example, in U.S. Pat. No. 5,504,128 (Mizutani et al.).

The binders of this disclosure can contain lithium polyacrylate as disclosed in co-owned application U.S. Ser. No. 11/671,601, filed on Feb. 6, 2007. Lithium polyacrylate can be made from poly(acrylic acid) that is neutralized with lithium hydroxide. U.S. Ser. No. 11/671,601 discloses that poly(acrylic acid) includes any polymer or copolymer of acrylic acid or methacrylic acid or their derivatives where at least about 50 mol %, at least about 60 mol %, at least about 70 mol %, at least about 80 mol %, or at least about 90 mol % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like. Of particular interest are polymers or copolymers of acrylic acid or methacrylic acid that are water soluble—especially after neutralization or partial neutralization. Water solubility is typically a function of the molecular weight of the polymer or copolymer and/or the composition. Poly(acrylic acid) is very water soluble and is preferred along with copolymers that contain significant mole fractions of acrylic acid. Poly(methacrylic) acid is less water soluble-particularly at larger molecular weights.

Homopolymers and copolymers of acrylic and methacrylic acid that are useful in this disclosure can have a molecular weight (M_{w}) of greater than about 10,000 grams/mole, greater than about 75,000 grams/mole, or even greater than about 450,000 grams/mole, or even higher. The homopolymers and copolymer that are useful in this disclosure have a molecular weight (M_{w}) of less than about 3,000,000 grams/mole, less than about 500,000 grams/mole, less than about 450,000 grams/mole or even lower. Carboxylic acidic groups on the polymers or copolymers can be neutralized by dissolving the polymers or copolymers in water or another suitable solvent such as tetrahydrofuran, dimethylsulfoxide, N,N-dimethylformamide, or one or more other dipolar aprotic solvents that are miscible with water. The carboxylic acid groups (acrylic acid or methacrylic acid) on the polymers or copolymers can be titrated with an aqueous solution of lithium hydroxide. For example, a solution of 34 wt % poly(acrylic acid) in water can be neutralized by titration with a 20 wt % solution of aqueous lithium hydroxide. Typically enough lithium hydroxide is added to neutralize, 50 percent or more, 60 percent or more, 70 percent or more, 80 percent or more, 90 percent or more, or even 100 percent of the carboxylic acid groups on a molar basis. In some embodiments excess lithium hydroxide is added so that the binder solution can contain greater than 100 percent, greater than 103 percent, greater than 107 percent or even more equivalents of lithium hydroxide on a molar basis based upon the amount of carboxylic acid groups.

Lithium polyacrylate can be blended with other polymeric materials to make a blend of materials. This can be done, for example, to increase the adhesion, to provide enhanced conductivity, to change the thermal properties or to affect other physical properties of the binder. Lithium polyacrylate is non-elastomeric. By non-elastomeric it is meant that the binders do not contain substantial amounts of natural or synthetic rubber. Synthetic rubbers include styrene-butadiene rubbers and latexes of styrene-butadiene rubbers. For example, lithium polyacrylate binders can contain less than about 20 wt %, less than about 10 wt %, less than about 5 wt %, less than about 2 wt %, or even less of natural or synthetic rubber.

Alloys can be made in the form of a thin film or powder, the form depending on the technique chosen to prepare the materials. Suitable methods of preparing the alloy compositions include, but are not limited to, sputtering, chemical vapor deposition, vacuum evaporation, melt spinning, splat cooling, spray atomization, electrochemical deposition, and ball milling. Sputtering is an effective procedure for producing amorphous alloy compositions.

Melt processing is another procedure that can be used to produce amorphous alloy compositions. According to one exemplary process, ingots containing the alloy composition can be melted in a radio frequency field and then ejected through a nozzle onto a surface of a rotating wheel (e.g., a copper wheel). Because the surface temperature of the rotating wheel is substantially lower than the temperature of the melt, contact with the surface of the rotating wheel quenches the melt. Rapid quenching minimizes the formation of crystalline material and favors the formation of amorphous materials. Suitable melt processing methods are further described in U.S. Pat. Appl. Publ. Nos. 2007/0020521 A1, 2007/0020522 A1, and 2007/0020528 A1 (all Obrovac et al). All of these are hereby incorporated by reference.

The sputtered or melt processed alloy compositions can be processed further to produce powdered active materials. For example, a ribbon or thin film of the alloy composition can be pulverized to form a powder. Powdered alloy particles can include a conductive coating. For example, a particle that contains silicon, copper, and silver or a silver alloy can be coated with a layer of conducting material (e.g., with the alloy composition in the particle core and the conductive material in the particle shell). When conductive coatings are employed, they can be formed using techniques such as electroplating, chemical vapor deposition, vacuum evaporation or sputtering. Suitable conductive materials include, for example, carbon, copper, silver, or nickel.

The disclosed electrodes can contain additional components such as will be familiar to those skilled in the art. The electrodes can include an electrically conductive diluent to facilitate electron transfer from the powdered composite to a current collector. Electrically conductive diluents include carbon powder (e.g., carbon black for negative electrodes and carbon black, flake graphite and the like for positive electrodes), metal, metal nitrides, metal carbides, metal silicides, and metal borides. Representative electrically conductive carbon diluents include carbon blacks, acetylene black, furnace black, lamp black, carbon fibers and combinations thereof.

In some embodiments of this invention the negative electrodes can include an adhesion promoter that promotes adhesion of the powdered composite and/or the electrically conductive diluent to the binder. The combination of an adhesion promoter and binder can help the electrode composition better accommodate volume changes that can occur in the powdered composite during repeated lithiation/delithiation cycles. Examples of adhesion promoters include silanes, titanates, and phosphonates as described in U.S. Pat. Appl. Publ. No. 2004/0058240 (Christensen), the disclosure of which is herein incorporated by reference.

To make a negative electrode, the composite of active material, any selected additional components such as binders, conductive diluents, adhesion promoters, thickening agents for coating viscosity modification such as carboxymethylcellulose, and other additives known by those skilled in the art can be mixed in a suitable coating solvent such as water or N-methylpyrrolidinone (NMP) to form a coating dispersion. The dispersion is mixed thoroughly and then applied to a foil current collector by any appropriate dispersion coating technique known to those skilled in the art. The current collectors are typically thin foils of conductive metals such as, for example, copper, stainless steel, or nickel foil. The slurry is coated onto the current collector foil and then allowed to dry in air followed usually by drying in a heated oven, typically at about 80° C. to about 300° C. for about an hour to remove all of the solvent. Then the electrode is pressed or compressed using any of a number of methods. For example the electrode can be compressed by rolling it between two calender rollers, by placing it under pressure in a static press, or by any other means of applying pressure to a flat surface known to those in the art. Typically pressures of greater than about 100 MPa, greater than about 500 MPa, greater than about 1 GPa, or even higher are used to compress the dried electrode and create low porosity powdered material.

Electrochemical cells of this disclosure can be made by taking at least one each of a positive electrode and a negative electrode as described above and placing them in an electrolyte. Typically, at least one microporous separator, such as CELGARD 2400 microporous material, available from Hoechst Celanese, Corp., Charlotte, N.C., is used to prevent the contact of the negative electrode directly with the positive electrode.

The electrochemical cells of this disclosure can be used in a variety of devices, including portable computers, personal digital assistants, mobile telephones, motorized devices (e.g., personal or household appliances and vehicles), instruments, illumination devices (e.g., flashlights) and heating devices. One or more electrochemical cells of this disclosure can be combined to provide battery pack. Further details regarding the construction and use of rechargeable lithium-ion cells and battery packs using the disclosed electrodes will be familiar to those skilled in the art.

The disclosure is further illustrated in the following illustrative examples, in which all percentages are by wt % unless otherwise indicated.

### EXAMPLES

### Preparatory Example 1

### Si₆₀Al₁₄Fe₈Ti₁Sn₇(MM)₁₀ Alloy Powder

Aluminum, silicon, iron, titanium and tin were obtained in an elemental form having high purity (99.8 wt % or greater) from Alfa Aesar, Ward Hill, Mass. or from Aldrich, Milwaukee, Wis. A mixture of rare earth elements, also known as Mischmetal (MM), was obtained from Alfa Aesar with 99.0 wt % minimum rare earth content which contained approximately 50 wt % cerium, 18 wt % neodymium, 6 wt % praseodymium, 22 wt % lanthanum, and 4 wt % other rare earth elements.

The alloy composition, Si₆₀Al₁₄Fe₈Ti₁Sn₇(MM)₁₀, was prepared by melting a mixture of 7.89 g aluminum shot, 35.18 g silicon flakes, 9.34 g iron shot, 1.00 g titanium granules, 17.35 g tin shot, and 29.26 g Mischmetal in an in an argon-filled arc furnace (available from Advanced Vacuum Systems, Ayer, Mass.) with a copper hearth to produce an ingot. The ingot was cut into strips using a diamond blade wet saw.

The ingots were then further processed by melt spinning. The melt spinning apparatus included a vacuum chamber having a cylindrical quartz glass crucible (16 mm internal diameter and 140 mm length) with a 0.35 mm orifice that was positioned above a rotating cooling wheel. The rotating cooling wheel (10 mm thick and 203 mm diameter) was fabricated from a copper alloy (Ni—Si—Cr—Cu C18000 alloy, 0.45 wt % chromium, 2.4 wt % nickel, 0.6 wt % silicon with the balance being copper) that is commercially available from Nonferrous Products, Inc., Franklin, Ind. Prior to processing, the edge surface of the cooling wheel was polished with a rubbing compound (available from 3M, St. Paul, Minn. as IMPERIAL MICROFINISHING) and then wiped with mineral oil to leave a thin film.

After placing a 20 g ingot strip in the crucible, the system was evacuated to 10.6 Pa and then filled with helium gas to 26.6 kPa. The ingot was melted using radio frequency induction. As the temperature reached 1350° C., 53.5 kPa helium pressure was applied to the surface of the molten alloy composition and the alloy composition was extruded through a nozzle onto the spinning (5031 revolutions per minute) cooling wheel. Ribbon strips were formed that had a width of 1 mm and a thickness of 10 μm. The ribbon strips were annealed at 200° C. for 2.5 hours under an argon atmosphere in a tube furnace.

### Examples 1A and 1B and Comparative Example 1

An electrode with a composition of 92.0 wt % of Si₆₀Al₁₄Fe₈Ti₁Sn₇(MM)₁₀ ball-milled alloy powder (average particle size 1 μm, density=3.76 g/cm³), 2.2 wt % Super P conductive diluent and 5.8 percent polyimide binder was prepared as follows. 1.84 g Si₆₀Al₁₄Fe₈Ti₁Sn₇(MM)₁₀ powder and 0.044 g of Super P carbon black were combined in a 45 mL stainless steel vessel with four 1.3 mm diameter tungsten carbide balls in a planetary micro mill (PULVERISETTE 7 Model, Fritsch, Germany) at a speed setting of 7 for 30 minutes. 0.58 g or a 20% solution of Polyimide 2555 (available from DuPont, Wilmington, Del.) and 1.5 mL of N-vinyl-2-pyrrolidinone (NMP) were then added to the vessel. Further mixing was carried out in the planetary micro mill at a speed of 5 for 30 additional minutes. The resulting mixture was coated onto a 12 μm thick electrolytic copper foil using a coating bar with a 125 μm gap. The coating was dried at 80° C. for 30 minutes and then at 120° C. under vacuum for 2 hours. The coating was then postcured at 300° C. under argon for 12 hours.

Half coin cells were prepared using 2325 button cells. All of the components were dried prior to assembly and the cell preparations were done in a dry room with a −70° C. dew point. The cells were constructed from the following components and in the following order, from the bottom up. Cu foil/Li metal film/Separator/Electrolyte/Separator/Alloy composite electrode/Cu foil. 100 μL of electrolyte solution was used to fill each cell. The cells were crimp sealed prior to testing.

The electrolytes for Examples 1A, 1B, and Comparative Example 1 contained 1M LiPF₆ in a 1:2 by volume solution of ethylene carbonate:diethylene carbonate. 10% fluoroethylene carbonate was added to Example 1A and 10% vinylene carbonate was added to Example 1B. Comparative Example 1 had no additives.

The cells were cycled from 0.005 to 0.9 V at a rate of C/4 at room temperature using a Maccor cycled. For each cycle, the cells were first discharged (lithiation of alloy) at a C/4 rate with a trickle current of 10 mA/g at the end of the discharge followed by a rest period of 15 minutes at open circuit. The cells were then charged at a C/4 rate followed by another 15 minutes rest at open circuit. The cells were run through many cycles to determine the extent of capacity fade as a function of the number of cycles completed. The results are shown in Table I.

TABLE I
Discharge Capacity Data for Coin Cells of Examples 1A, 1B and Comparative Example 1

| | | Discharge | Irreversible | Capacity Fade - | Total Capacity |
|---|---|---|---|---|---|
| | | Capacity - first | Capacity - first | cycle 2 to 70 | Fade - cycle 1 |
| Example | Electrolyte | cycle (mAh/g) | cycle (percent) | (percent) | to 70 (percent) |
| Example 1a | EC:DEC + 10 | 997 | 20.36 | 7.98 | 28.34 |
| | percent FEC | | | | |
| Example 1b | EC:DEC + 10 | 1029 | 23.43 | 6.95 | 30.38 |
| | percent VC | | | | |
| Comparative | EC:DEC | 1006 | 21.10 | 58.28 | 79.38 |
| Example 1 | | | | | |

The data in Table 1 show the positive effect of fluoroethylene carbonate and vinylene carbonate additives to electrochemical cells of this disclosure.

What is claimed is:

1. A lithium ion electrochemical cell comprising:
an electrolyte comprising a vinylene carbonate additive having the structure 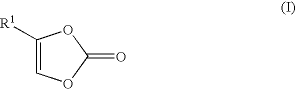
wherein R¹ is H or a C₁-C₄ alkyl or alkenyl group; and
an anode composition comprising at least one of:
(i) a composition comprising a material having the formula, SiₓSn_{q}M¹_{y}C_{z}, wherein q, x, y, and z represent mol % s and each mol % is based upon the number of moles of all elements except Li in the composition, (q+x)>2y+z, q and
z≧0, M¹ is selected from a transition metal, Y, or a combination thereof, wherein the Si, Sn, M¹, and C elements are arranged in the form of a multi-phase microstructure comprising an amorphous phase comprising Si, a nanocrystalline phase comprising a metal silicide, an amorphous phase comprising Sn when q>0, and a phase comprising a silicon carbide when z>0;
(ii) a composition comprising a material having the formula, SiₐAl_{b}M²_{c}Sn_{d}E¹ₑInₚ, wherein a, b, c, d, e, and p represent mol % s and each mol % is based upon the number of moles of all elements except Li in the composition, M² is selected from a transition metal or a combination of transition metals, E¹ comprises Y, a lanthanide, an actinide, or a combination thereof, 35≦a≦70, 1≦b≦45, 5≦c≦25, 1≦d≦15, 2≦e≦15, and 0≦p≦15, and wherein the alloy composition is a mixture of an amorphous phase comprising Si and a nanocrystalline phase comprising E¹ and Sn when p=0 or E¹, Sn, and In when p>0;
(iii) a composition comprising a material having the formula, Sn_{f}E²_{g}E³ₕAᵢM³ⱼ, wherein f, g, h, i, and j represent mol % s and each mol % is based upon the number of moles of all elements except Li in the composition, 1≦f≦50, 20≦g≦95, h≧3, i=0 or 3≦i≦50, and 0≦j≦1, E² comprises Si, Al, or a combination thereof, E³ comprises Y, a lanthanide, an actinide, or a combination thereof, “A” comprises an alkaline earth element; and M³ comprises an element selected from Fe, Mg, Si, Mo, Zn, Ca, Cu, Cr, Pb, Ti, Mn, C, S, P, or a combination thereof, or
(iv) a composition comprising a material having the formula, SiₖCuₘAgₙ wherein k, m, and n represent mol % s and each mol % is based upon the number of moles of all elements except Li in the composition, k≧10, m≧3, and wherein 1≦n≦50 based upon moles of the alloy composition.

2. The electrochemical cell of claim 1 wherein R is H.

3. The electrochemical cell of claim 1 wherein R comprises a C₁-C₄ alkyl or alkenyl group.

4. The electrochemical cell of claim 1 wherein M¹ is selected from Mn, Mo, Nb, W, Ta, Fe, Cu, Ti, V, Cr, Ni, Co, Zr, Y, or a combination thereof, and M² is selected from Ti, V, Cr, Mn, Fe, Co, Ni, Cu Zr, Nb, Mo, W or a combination thereof.

5. The electrochemical cell of claim 1 wherein the anode composition further comprises lithium.

6. A battery pack comprising one or more of the electrochemical cells of claim 1.

7. A lithium ion electrochemical cell comprising:
an electrolyte additive comprising an ethylene carbonate having the structure 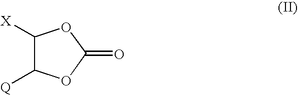
wherein X is H, F, or Cl; and Q is F or Cl or a C₁-C₄ alkyl or alkenyl group;
an anode composition comprising at least one of:
(i) a composition comprising a material having the formula, SiₐAl_{b}M²_{c}Sn_{d}E¹ₑInₚ, wherein a, b, c, d, e, and p represent mol % s and each mol % is based upon the number of moles of all elements except Li in the composition, M² is selected from a transition metal or a combination of transition metals, E¹ comprises Y, a lanthanide, an actinide, or a combination thereof, 35≦a≦70, 1≦b≦45, 5≦c≦25, 1≦d≦15, 2≦e≦15, and 0≦p≦15, and wherein the alloy composition is a mixture of an amorphous phase comprising Si and a nanocrystalline phase comprising E¹ and Sn when p=0 or E¹, Sn, and In when p>0;
(ii) a composition comprising a material having the formula, Sn_{f}E²_{g}E³ₕAᵢM³j, wherein f, g, h, i, and j represent mol % s and each mol % is based upon the number of moles of all elements except Li in the composition, 1≦f≦50, 20≦g≦95, h≧3, i=0 or 3≦i≦50, and 0≦j≦1, E² comprises Si, Al, or a combination thereof, E³ comprises Y, a lanthanide, an actinide, or a combination thereof, “A” comprises an alkaline earth element; and M³ comprises an element selected from Fe, Mg, Si, Mo, Zn, Ca, Cu, Cr, Pb, Ti, Mn, C, S, P, or a combination thereof; or
(iii) a composition comprising a material having the formula, SiₖCuₘAgₙ, wherein k, m, and n represent mol % s and each mol % is based upon the number of moles of all elements except Li in the composition, k≧10, m≧3, and wherein 1≦n≦50 based upon moles of the alloy composition.

8. The electrochemical cell of claim 7 wherein X is hydrogen and Q is fluorine.

9. The electrochemical cell of claim 7 wherein X is fluorine and Q is fluorine.

10. The electrochemical cell of claim 7 wherein X is hydrogen and Q is —CH═CH₂.

11. The electrochemical cell of claim 7 wherein M¹ is selected from Mn, Mo, Nb, W, Ta, Fe, Cu, Ti, V, Cr, Ni, Co, Zr, Y, or a combination thereof and M² is selected from Ti, V, Cr, Mn, Fe, Co, Ni, Cu Zr, Nb, Mo, W or a combination thereof.

12. The electrochemical cell of claim 7 wherein the anode composition further comprises lithium.

13. A battery pack comprising one or more of the electrochemical cells of claim 7.

14. An electrochemical cell comprising:
an electrolyte additive comprising at least one of
a) a vinylene carbonate having the structure 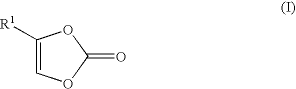
or
b) an ethylene carbonate having the structure 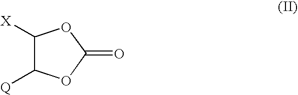
wherein R¹ is H or an alkyl or alkenyl group containing one to four carbon atoms; X is H, F, or Cl; and Q is F or Cl or a C₁-C₄ alkyl or alkenyl group; and
an electrode composition comprising particles having an average particle size ranging from about 1 μm to about 50 μm,
wherein the particles comprise an electrochemically active phase and an electrochemically inactive phase that share at least one common phase boundary,
wherein the electrochemically inactive phase comprises at least two metal elements in the form of an intermetallic compound, a solid solution, or combination thereof, and
wherein
(a) each of the phases is free of crystallites that are greater than 1000 angstroms prior to cycling, and
(b) the electrochemically active phase is amorphous after the electrode has been cycled through one full charge-discharge cycle in a lithium-ion battery.

15. The cell of claim 14 wherein the electrochemically active phase comprises silicon.

16. The cell of claim 14 wherein the electrochemically inactive phase comprises at least two metal elements selected from, iron, nickel, manganese, cobalt, copper, titanium, or chromium.

17. The cell of claim 14 wherein the electrochemically inactive phase further comprises silicon.

18. The cell of claim 14 wherein the electrolyte comprises vinylene carbonate.

19. The cell of claim 14 wherein the electrolyte comprises fluoroethylene carbonate.

20. The electrochemical cell of claim 14 wherein the anode composition further comprises lithium.

21. A battery pack comprising one or more of the electrochemical cells of claim 14.
